(19) United States
(12) Patent Application Publication
(10) Pub. No.: US 2005/0111831 A1
(43) Pub. Date: May 26, 2005

(54) Recording and reproducing system, recording and reproducing method, program and record medium

(76) Inventors: Chiyoko Matsumi, Osaka (JP); Keisuke Matsuo, Nara (JP); Harutoshi Miyamoto, Osaka (JP); Nobuyasu Takeguchi, Osaka (JP); Yasuyuki Torii, Kyoto (JP); Toshihiko Mizukami, Osaka (JP); Kevin Leigh La Chapelle, Redmond, WA (US); Ian Cameron Mercer, Sammammish, WA (US)

Correspondence Address: SMITH GAMBRELL & RUSSELL LLP, Suite 800, 1850 M Street N W, Washington, DC, 20036, US

(21) Appl. No.: 10/725,931

(22) Filed: Dec. 3, 2003

Related U.S. Application Data
(60) Provisional application No. 60/433,010, filed on Dec. 13, 2002.

(51) Int. Cl. H04N 5/76; H04N 5/781

(52) U.S. Cl. 386/95; 386/125

(57) ABSTRACT

[Problems] There has been a problem that it takes time from insertion of a record medium until it becomes reproducible.
[Means for Solution] A recording and reproducing system has a record medium 15 of holding a data file 13 of storing predetermined data, a file recording means 14 of recording data file holding position information on a position at which the data file 13 is held in a data file holding position information file 17 held on the record medium 15 of storing the data file holding position information, a data recording state obtaining means 18, a recording position information file creating means 34, and a file reproducing means 23 of reproducing the predetermined data stored in the data file 13 by using the recorded data file holding position information.

### DETAILED DESCRIPTION OF THE INVENTION

1. Field of the Invention

The present invention relates to a recording and reproducing system, a recording and reproducing method, a program and a record medium.

2. Prior Art

A record medium has a data file recorded thereon according to a predetermined file system. Therefore, when reproducing it, the file system is analyzed based on a file name of the data file and a recording position of the data file on the record medium is obtained so as to access and read the data file which is desired. Although it is possible to obtain the recording position of the data file each time the data file to be reproduced is selected, it takes time for a reproducing apparatus of low performance to analyze the file system, and so it is normal, on insertion of the record medium, to obtain the recording positions of all the reproducible data files and record in a memory the recording positions associated to the data files. In this case, it is possible to immediately read the desired data file based on the recording position stored in the memory.

In the case of having no high-speed microcomputer mounted, however, it takes time to obtain the recording positions of individual data files by analyzing the file system, where it takes more time in proportion to the increasing number of the data files recorded on the record medium. As a result, there was a problem that it takes time from the insertion of the record medium until it becomes reproducible.

### MEANS TO SOLVE THE PROBLEMS

In consideration of the above problem in the past, an object of the present invention is to provide a recording and reproducing system, a recording and reproducing method, a program and a record medium capable of performing reproduction more promptly after the record medium is inserted.

The 1^{st} aspect of the present invention is a recording and reproducing system comprising:

a record medium (15) holding a data file (13) of storing predetermined data;

data file holding position information file recording means (14, 18, 34) of recording data file holding position information on a position at which said data file (13) is held in a data file holding position information file (17) held on said record medium (15) of storing said data file holding position information; and

data reproducing means (23) of reproducing the predetermined data stored by said data file (13) by using said data file holding position information which is recorded.

The 2^{nd} aspect of the present invention is the recording and reproducing system according to the 1^{st} aspect of the present invention, wherein:

said record medium (15) holds a plurality of said data files (13), and

said data file holding position information file (17) stores all the data file holding position information on the positions at which said plurality of data files (13) are held respectively.

The 3^{rd} aspect of the present invention is the recording and reproducing system according to the 2^{nd} aspect of the present invention, wherein:

said data file (13) further stores parameter information used for reproducing said predetermined data;

parameter information recording means (14, 32, 33) of recording said parameter information in a parameter information file (16) held on said record medium (15) of storing said parameter information is further provided; and

said data reproducing means (23) reproduces the predetermined data stored by said data file (13) by further using said parameter information which is recorded.

The 4^{th} aspect of the present invention is the recording and reproducing system according to the 3^{rd} aspect of the present invention, wherein said plurality of said data files (13) are given unique data file IDs by using order in which said parameter information file (16) stores said parameter information respectively.

The 5^{th} aspect of the present invention is the recording and reproducing system according to the 4^{th} aspect of the present invention, wherein said data file (13) holding position information on the positions at which said respective data files are held is recorded in said data file holding position information file (17) by using said unique data file IDs which are given.

The 6^{th} aspect of the present invention is a recording and reproducing method comprising:

a data file holding position information file recording step of recording data file holding position information on a position at which a data file of storing predetermined data is held in a data file holding position information file held by a record medium holding said data file and said data file holding position information file; and

a data reproducing step of reproducing the predetermined data stored by said data file by using said data file holding position information which is recorded.

The 7^{th} aspect of the present invention is a program of, per recording and reproducing method according to the 6^{th} aspect of the present invention, causing a computer to execute:

the data file holding position information file recording step of recording data file holding position information on a position at which a data file of storing predetermined data is held in a data file holding position information file held by a record medium holding said data file and said data file holding position information file; and

the data reproducing step of reproducing the predetermined data stored by said data file by using said data file holding position information which is recorded.

The 8^{th} aspect of the present invention is a record medium processable by a computer and supporting the program according to the 7^{th} aspect of the present invention.

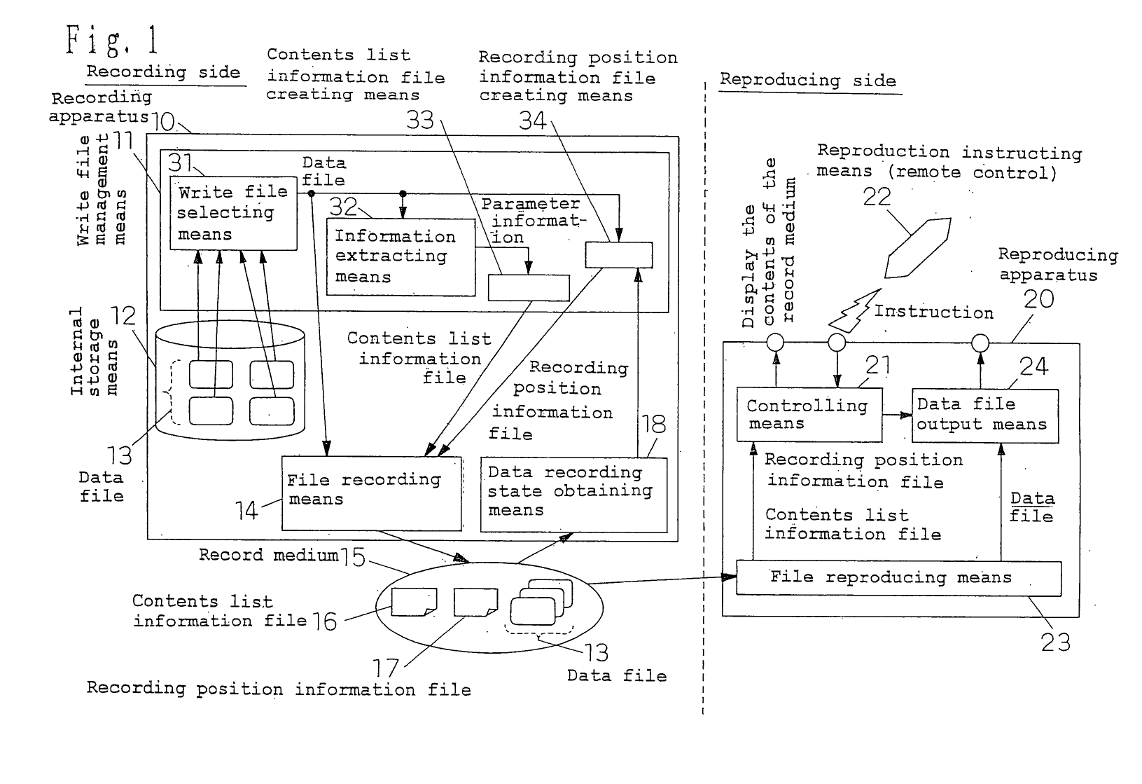

### BRIEF DESCRIPTION OF THE DRAWINGS

[FIG. 1]

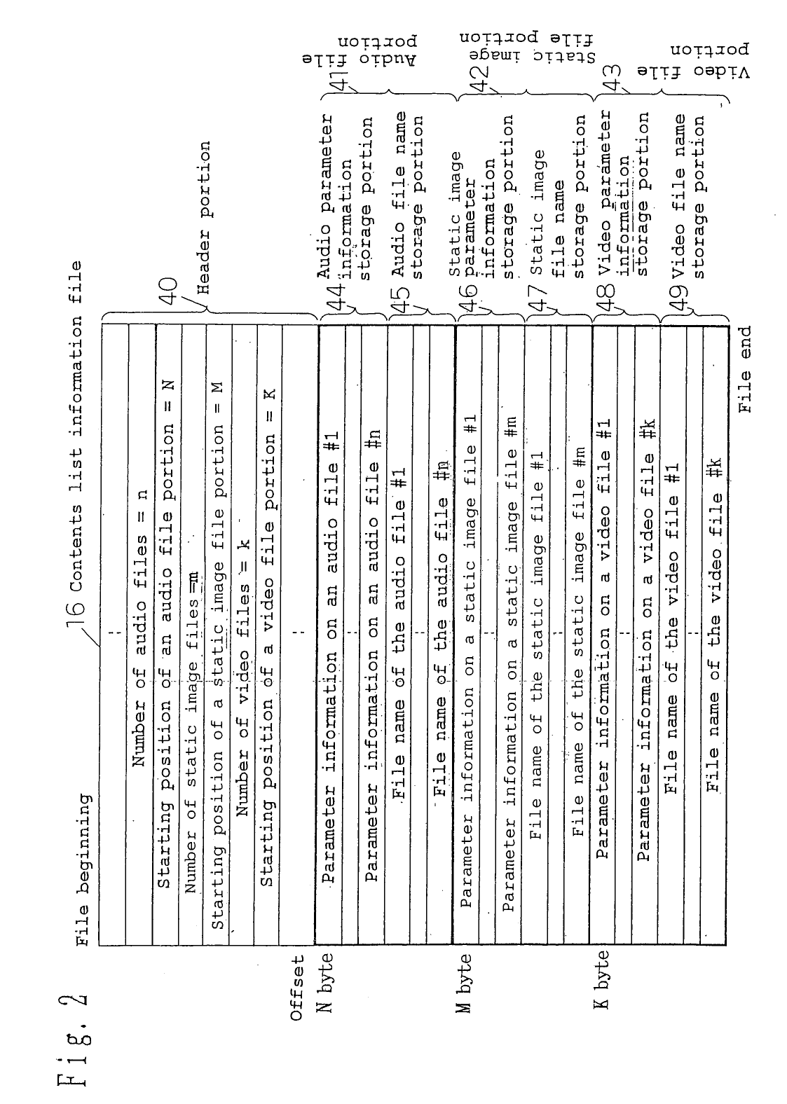

An explanatory diagram of a recording and reproducing system according to a first embodiment of the present invention.

[FIG. 2]

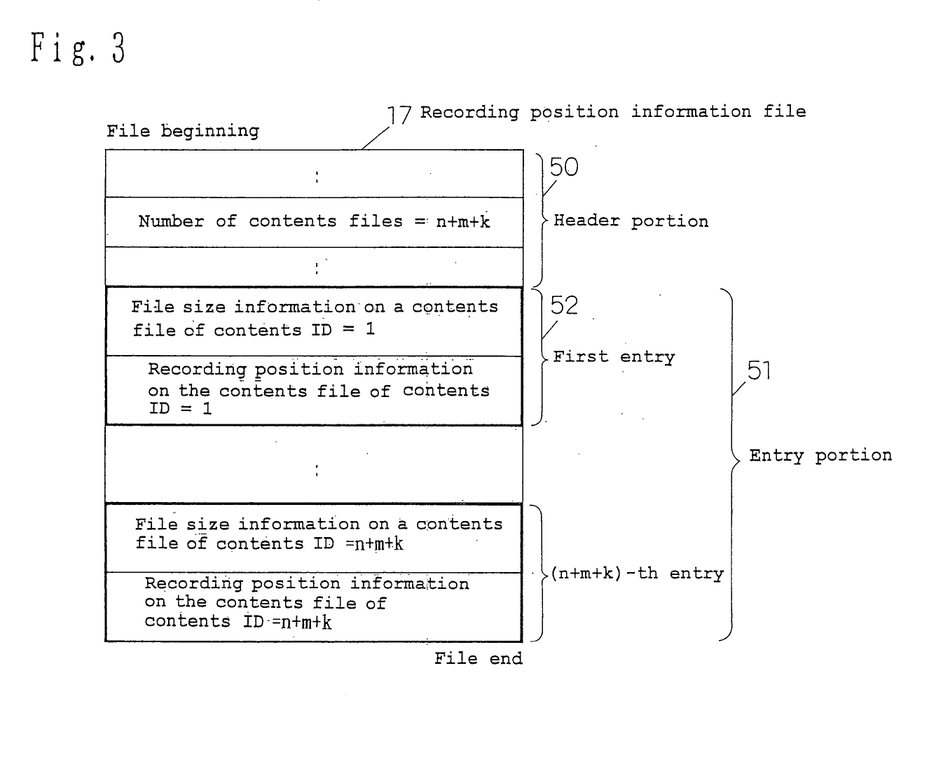

An explanatory diagram of a data storage format of a contents list information file 16 according to the first embodiment of the present invention.

[FIG. 3]

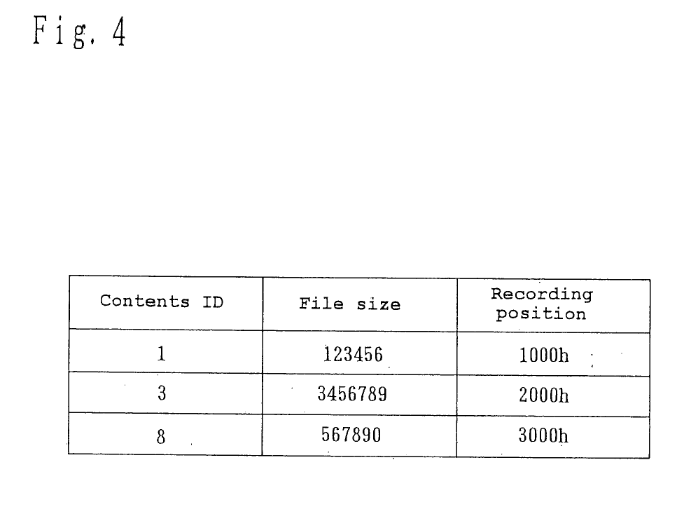

An explanatory diagram of the data storage format of a recording position information file 17 according to the first embodiment of the present invention.

[FIG. 4]

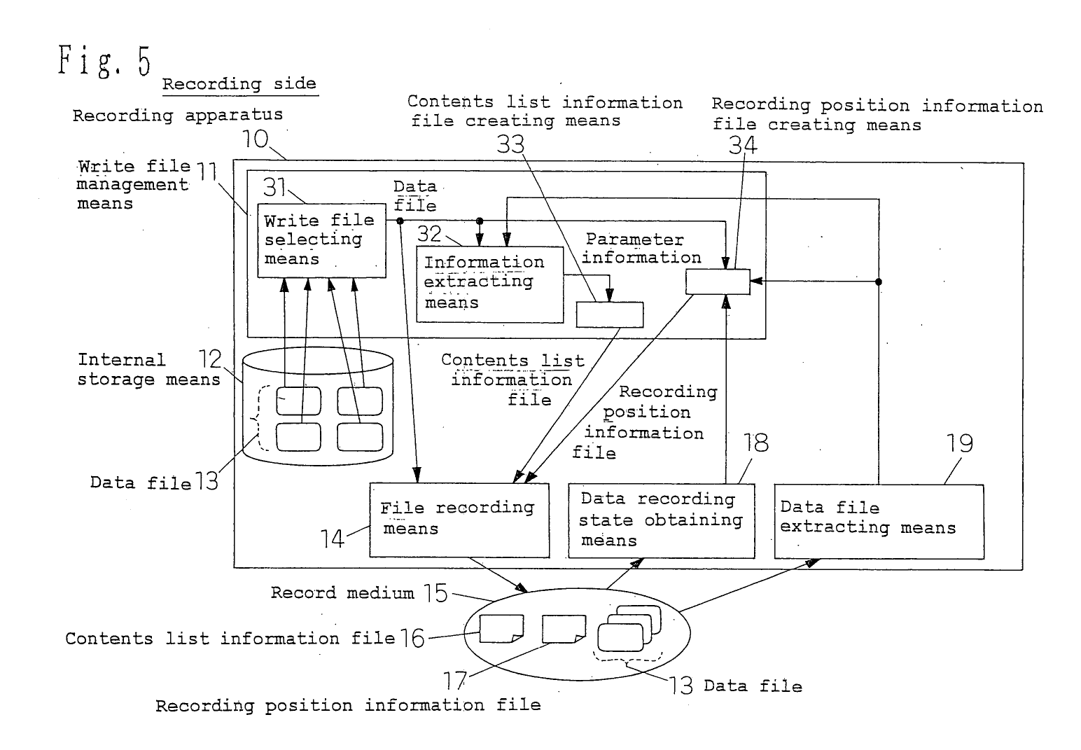

An explanatory diagram of a data file list created in an internal memory of a reproducing apparatus 20 according to the first embodiment of the present invention.

[FIG. 5]

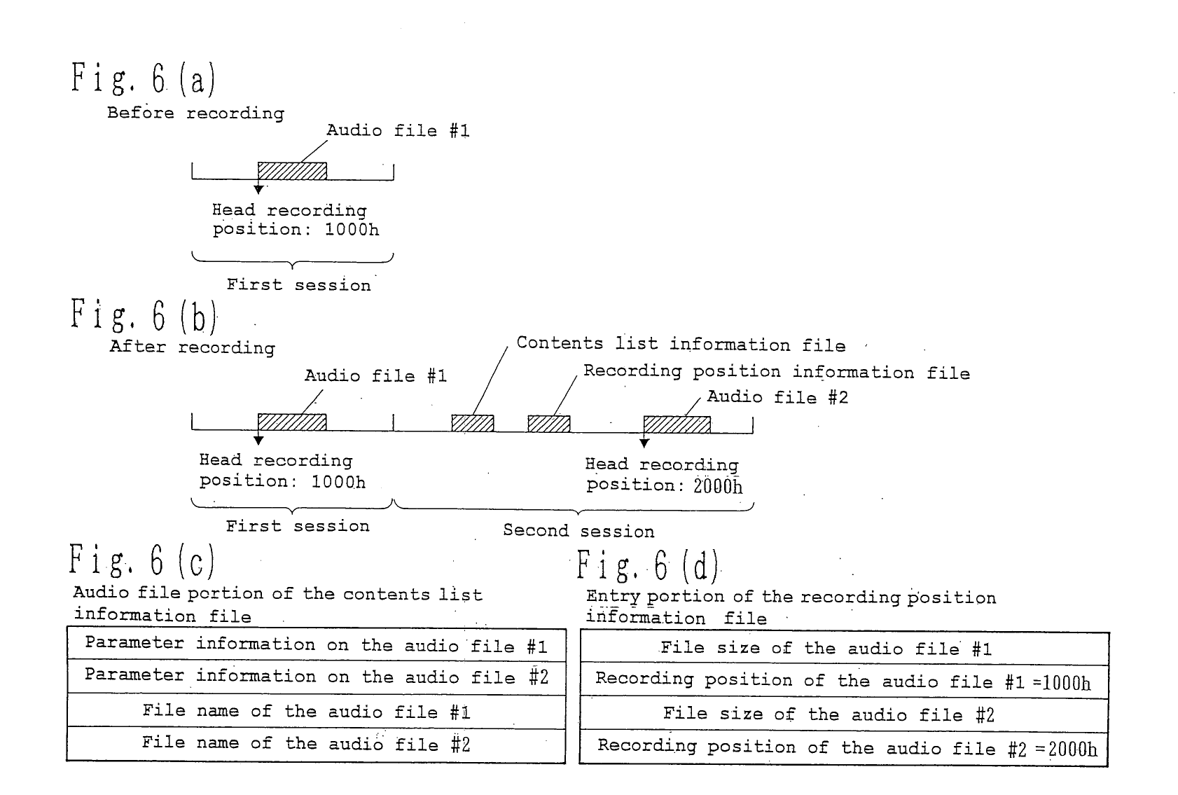

An explanatory diagram of the data file list created in the internal memory of the reproducing apparatus 20 according to a second embodiment of the present invention.

[FIG. 6]

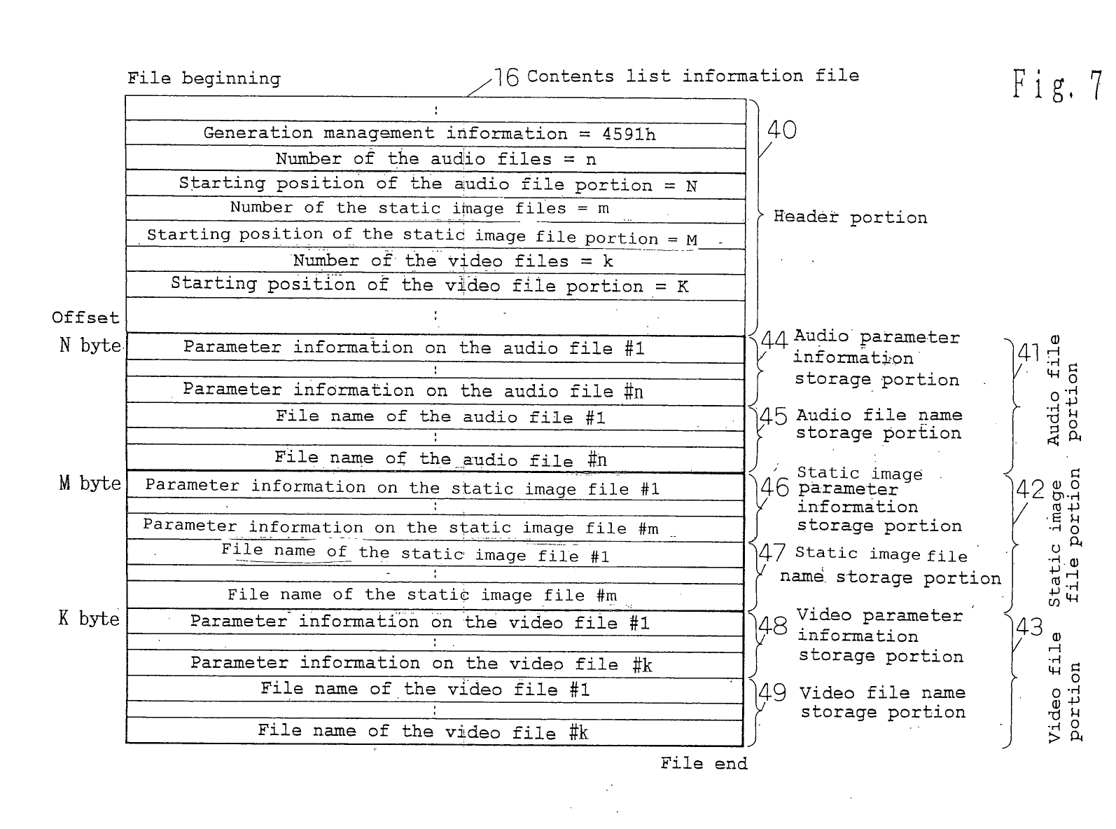

An explanatory diagram of operation in the case of being appended by using a CD-R medium as a record medium 15 according to the second embodiment of the present invention.

[FIG. 7]

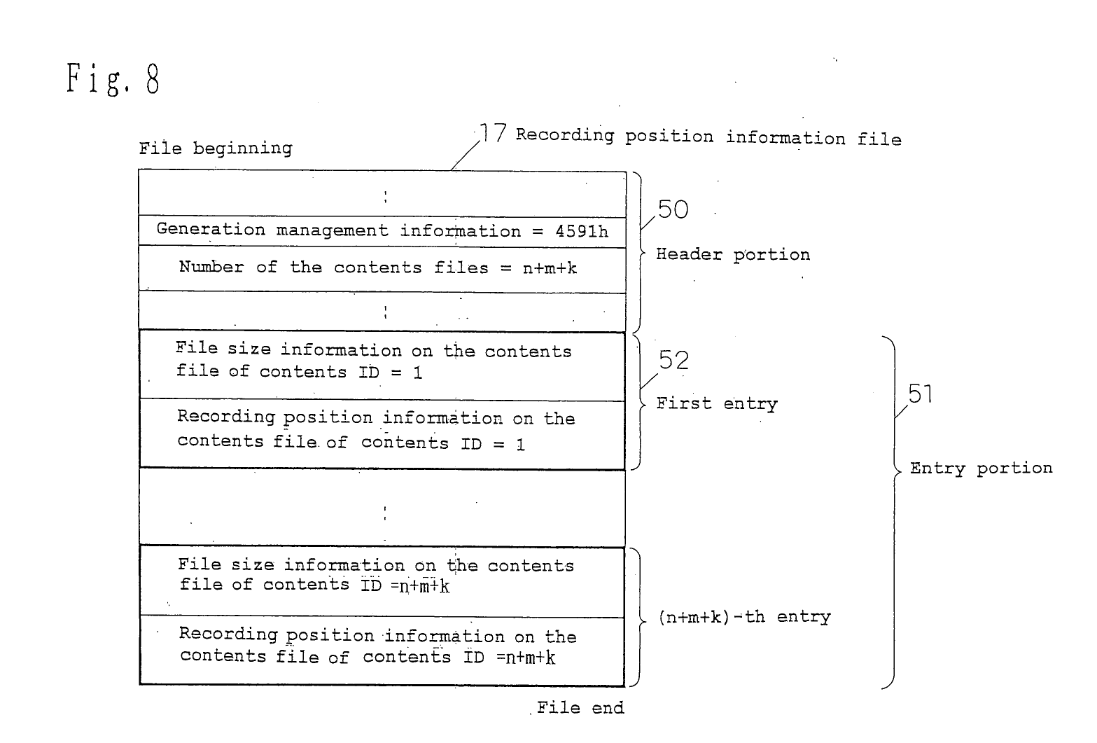

An explanatory diagram of a contents list information file according to a third embodiment of the present invention.

[FIG. 8]

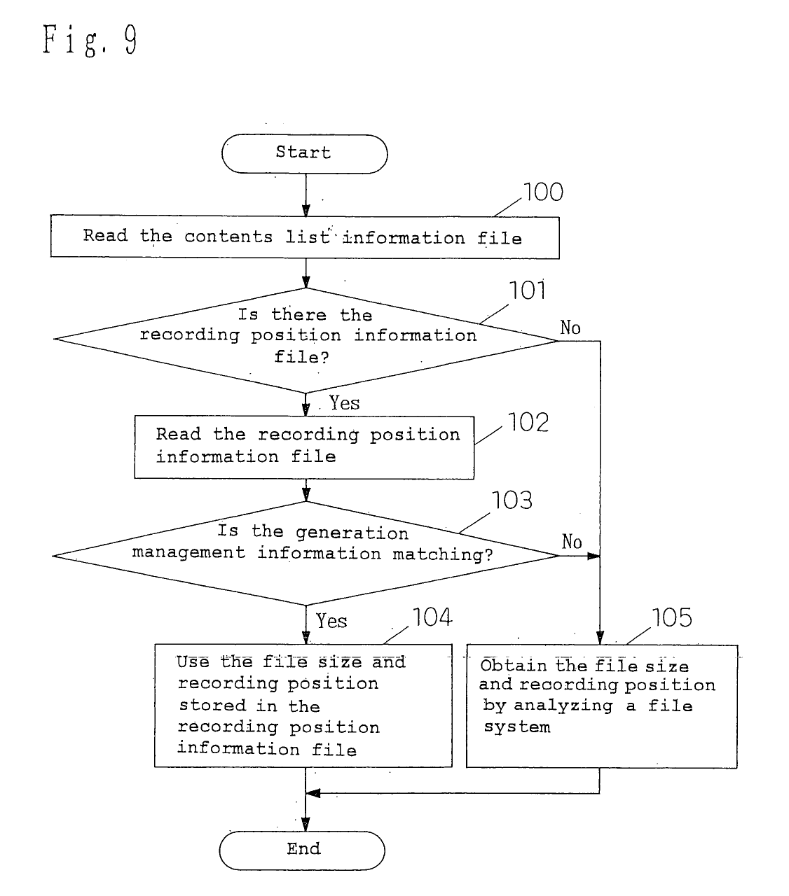

An explanatory diagram of a recording position information file according to the third embodiment of the sent invention.

[FIG. 9]

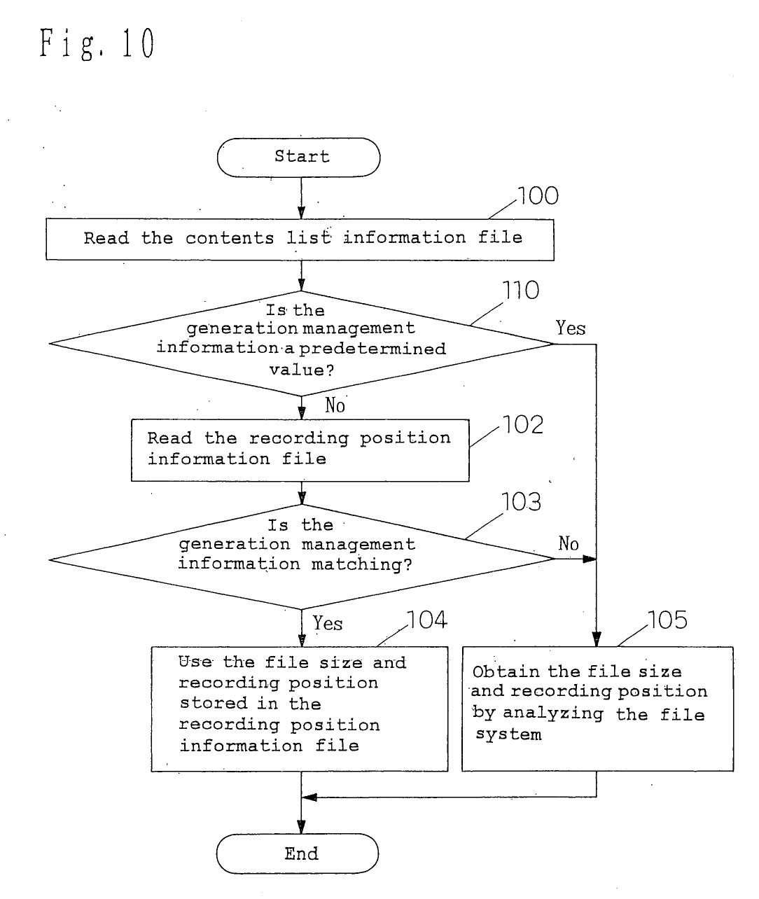

A flowchart showing a flow of a process of the preparation for reproduction when a reproducing apparatus 10 detects insertion of a record medium according to the third embodiment of the present invention.

[FIG. 10]

A flowchart showing the flow of the operation process of the preparation for reproduction according to a fourth embodiment of the present invention.

### DESCRIPTION OF REFERENCE NUMERALS

10 Recording apparatus
11 Write file management means
12 Internal storage means
13 Data file
14 File recording means
15 Record medium
16 Contents list information file
17 Recording position information file
18 Recording position information file creating means
20 Reproducing apparatus
21 Controlling means
22 Reproduction instructing means
23 File reproducing means
24 Data file output means
31 Write file selecting means
32 Information extracting means
33 Contents list information file creating means
35 Data recording state obtaining means

### PREFERRED EMBODIMENTS OF THE INVENTION

Hereafter, embodiments of the present invention will be described.

(First Embodiment)

FIG. 1 is a recording and reproducing system according to a first embodiment of the present invention. In FIG. 1, reference numeral 10 denotes a recording apparatus, 11 denotes write file management means, 12 denotes internal storage means, 13 denotes a data file, 14 denotes file recording means, 15 denotes a record medium, 16 denotes a contents list information file, 17 denotes a recording position information file, 18 denotes recording position information file creating means, 20 denotes a reproducing apparatus, 21 denotes controlling means, 22 denotes reproduction instructing means, 23 denotes file reproducing means, 24 denotes data file output means, 31 denotes write file selecting means, 32 denotes information extracting means, 33 denotes contents list information file creating means and 35 denotes data recording state obtaining means.

This system is a system of reproducing the record medium 15 on which the data file is recorded by the recording apparatus 10 comprised of the write file management means 11, internal storage means 12, file recording means 14 and data recording state obtaining means 18 on the reproducing apparatus 20 comprised of the controlling means 21, reproduction instructing means 22, file reproducing means 23 and data file output means 24. The write file management means 11 is comprised of the write file selecting means 31, information extracting means 32, contents list information file creating means 33 and recording position information file creating means 34.

Hereafter, operation will be described by referring to the drawings.

First, on a recording side, the write file selecting means 31 selects from the internal storage means 12 the data file 13 to be recorded on the record medium 15, and the information extracting means 32 extracts from the selected data file 13 information related to data stored in the data file. The contents list information file creating means 33 creates the contents list information file 16 storing unique parameter information defining at least the data itself stored in the data file 13 by associating the parameter information with the data file 13 of the information extracted by the information extracting means 32. Here, as for image data for instance, the unique parameter information may include an image size, a frame rate and a data rate, encode information, reproduction duration and so on of defining the image data stored as header information in the AVI, wmv or asf file format. And in the case of audio data, it may include a sampling frequency, the number of channels, compression method information, play duration, the data rate and so on of defining the audio data stored as the header information in the AVI, wma or asf file format. On detecting that the record medium 15 is inserted, the data recording state obtaining means 18 reads the data from the record medium 15 to check whether or not there is recording data, and in the case where the data already exists and is to be appended, it gathers the data on the file system required for appending from the data which has already been recorded. Based on the data gathered by the data recording state obtaining means 18, the recording position information file creating means 34 calculates as recording position information in advance a position (logical sector number) on the record medium 15 at which a head of each of the data files 13 selected by the write file selecting means 31 is recorded, and creates a recording position information file storing the recording position information and file sizes associated with each of the data files 13. The file recording means 14 records the data files 13, contents list information file 16 and recording position information file 17 on the record medium 15. Here, it is possible to calculate the recording position information and file sizes by using the past technology since they are recorded as the data of the file system according to the past technology, and so detailed description thereof will be omitted.

Next, on a reproducing side, the file reproducing means 23 follows an instruction of the controlling means 21 to read the contents of the contents list information file 16 recorded on the record medium 15, and identifies the data files 13 in which the data capable of outputting by the data file output means 24 is stored of the data files 13 recorded on the record medium 15 so as to store a list thereof as a data file list in an internal memory. Furthermore, it reads the contents of the recording position information file 17 and adds to the data files 13 listed on the above described data file list the recording position information on these data files. If the data file 13 to be outputted according to an instruction of the reproduction instructing means 22 is selected of the data files 13 listed on the data file list, the recording position of that file is obtained from the list stored in the internal memory and reproduction is started from that recording position so that a desired data file 13 is read from the record medium 15. The data file out put means 24 converts the contents of the data file 13 which was read from a file format to an output format and outputs it.

FIG. 2 shows an example of a data storage format of the contents list information file 16. The contents list information file 16 is comprised of a header portion 40, an audio file portion 41, a static image file portion 42 and a video file portion 43, where the audio file portion 41 is comprised of an audio parameter information storage portion 44 and an audio file name storage portion 45, the static image file portion 42 is comprised of a static image parameter information storage portion 46 and a static image file name storage portion 47, and the video file portion 43 is comprised of a video parameter information storage portion 48 and a video file name storage portion 49.

In FIG. 2, the data file 13 is comprised of n pieces of audio file, m pieces of static image file and k pieces of video file which makes (n+m+k) pieces of files, and the respective numbers of the files are stored in the header portion 40. The header portion 40 stores values in bytes representing the respective starting positions of the audio file portion 41, static image file portion 42 and video file portion 43 as offsets from a file head. The audio parameter information storage portion 44 stores in order the parameter information extracted from each of audio files #1, . . . , #n, and the audio file name storage portion 46 stores in order the file names of each of the audio files #1, . . . , #n. Likewise, as to the static image files and video files, the extracted parameter information and file name information are stored in the static image file portion 42 and video file portion 43.

Here, IDs (hereafter referred to as contents IDs) are assigned to corresponding data files in order in which the parameter information was stored in the contents list information file 16. To be more specific, as for the example shown in FIG. 2, contents IDs=1, . . . , n are assigned to the audio files #1, . . . , #n, contents IDs=(n+1), . . . , (n+m) are assigned to the static image files #1, . . . , #m, and contents IDs=(n+m+1), . . . , (n+m+k) are assigned to the video files #1, . . . , #k respectively.

FIG. 3 shows an example of the data storage format of the recording position information file 17. The recording position information file 17 is comprised of a header portion 50 and an entry portion 51. The header portion 50 stores the number of entries to be stored in the entry portion 51. This number is the same as the number of the data files ((n+m+k) pieces in the example in FIG. 2) of storing the parameter information in the contents list information file 16. The entry portion 51 stores first to the (n+m+k)-th entries. The i-th entry (i=1, . . . , (n+m+k)) stores file size information on the data file 13 to which a contents ID=i is assigned and the recording position information (logical sector number) on the file head. Here, the contents ID means the one defined in the contents list information file 16.

FIG. 4 shows an example of the data file list created in the internal memory of the reproducing apparatus 20. On the assumption that, according to a determination, the data files 13 capable of outputting by the reproducing apparatus 20 are those of three contents IDs=1, 3, 8 based on the contents stored in the contents list information file 16, the list is created by obtaining the file size and recording position of each data file from the recording position information file 17.

Configuration and operation of the recording and reproducing system according to the first embodiment of the present invention are as described above. According to the first embodiment of the present invention, it is possible, just by reading the contents list information file, to identify reproducible data files from the stored parameter information, and so it is not necessary to read the data and check whether it is in a reproducible format piece by piece as to all the files, so that only the files in easily reproducible data formats can be presented to the user to select the files to be reproduced thereof.

In addition, it is possible, just by reading the recording position information file, to know the recording positions of all the contents files, and so it is not necessary to analyze the file system for the sake of obtaining the recording positions. Moreover, as the contents ID can be represented by a 32-bit ID for instance, it is possible to render the file size of the recording position information file smaller compared to the case of storing it as directly associated with the filename, and so the time required for reading the recording position information file can be shortened and consequently the time of obtaining the recording positions can be significantly shortened so as to provide a reproducing apparatus of high responsivity and shortened startup time.

In addition, it classifies the data files according to data formats such as the audio, static image and video to store them in the contents list information file, and stores storage positions of the respective classes in the header portion. Thus, for instance, the reproducing apparatus capable of only reproducing the audio files does not require any information other than the information on the audio files so that, when reading the contents list information file, it is possible to read only the information of the audio file portion without reading any other portion based on the information of the header portion and consequently reduce the time of a reading process and also hold down a memory amount of storing the read data so as to provide an inexpensive reproducing apparatus of-high responsivity.

(Second Embodiment)

FIG. 5 shows the configuration of the recording apparatus 10 according to a second embodiment. It is different from the recording apparatus 10 according to the first embodiment shown in FIG. 1 in that data file extracting means 19 is added. Otherwise, the configuration is the same as that in FIG. 1 so that the same reference numerals are given and the description thereof will be omitted. In addition, the reproducing apparatus 20 has the same configuration as that according to the first embodiment shown in FIG. 1.

Hereafter, the operation of the recording apparatus according to the second embodiment will be described by referring to the drawings.

On detecting that the record medium 15 is inserted, the data file extracting means 19 reads the data on the record medium 15 to search the data file of which information is to be stored in the contents list information file, and extracts a subject data file. The information extracting means 32 is different from the first embodiment only in that it extracts the information from the data files 13 selected by the write file selecting means 31 and the data files 13 extracted by the data file extracting means. The recording position information file creating means 34 is different from the first embodiment only in that it extracts the information from the data files 13 selected by the write file selecting means 31 and the data files 13 extracted by the data file extracting means. As the operation of the other components is the same as that in the first embodiment, the description thereof will be omitted.

As described above, according to the second embodiment, it performs the operation so that all the recorded contents files of the data files 13 recorded on the record medium 15 are extracted, and as for of the extracted data files, predetermined information thereof is stored in the contents list information file 16 and recording position information file 17 as with the data files 13 selected from the internal storage means 12.

FIG. 6 is a diagram explaining the operation in the case of being appended by using the CD-R medium as the record medium 15. The CD-R medium appends the data by using a concept of a session.

Hereafter, a method of creating the contents list information file 16 and recording position information file 17 will be described by referring to the drawings.

FIG. 6A shows a state of the record medium before recording on the recording apparatus according to this embodiment. A first session has the audio file #1 recorded therein, and shows that its head recording position is 1000h. FIG. 6B shows the state of the record medium after recording the audio file #2 and further recording the contents list information file and recording position information file. The appended file is recorded in the second session. The head recording position of the audio file #2 is 2000h. The contents list information file has the information of the audio file #1 and the audio file #2 stored therein, and is recorded in the second session. The audio file portion of the contents list information file at this time is as shown in FIG. 6C. FIG. 6D shows the entry portion of the recording position information file. The file sizes and recording positions of the audio file #1 and the audio file #2 are stored therein respectively. The recording position of the audio file #1 can be obtained from the file system by reading the record medium in the state of FIG. 6A, and as previously mentioned, it can be calculated that the recording position of the audio file #2 is 2000h before recording.

Thus, it is possible to create and append the contents list information file and recording position information file to the data files already recorded on the record medium having the data files recorded thereon by a method in the past, and so the record medium according to the present invention can be easily created from the record medium recorded by the method in the past, so that an excellent effect of accelerating a startup on the reproduction can be obtained.

Moreover, it was described that the data files recorded in advance on the record medium 15 are automatically extracted by the data file extracting means 19, but it is also possible for the user to select them.

Moreover, while the sessions increase each time the data is appended as described in the second embodiment, an effective contents list information file is recorded in a final session. Therefore, when reproducing it, it is necessary, by using the technology in the past, to follow the sessions in order from a leading session and analyze the file system after detecting the final session so as to access the contents list information file. As the process of following the sessions takes considerable time in the reproducing apparatus, the more sessions there are, the longer it takes for startup. If the disk is finalized, it becomes clear that the (N+1)-th session does not exist on detecting the N-th session on the disk having N pieces of sessions, and so it is not necessary to check whether or not the (N+1)-th session exists and the startup is accelerated accordingly. In addition, if the disk is finalized after creating one session, it immediately becomes clear that the second session or any session thereafter does not exist so that no process of following the sessions arises and thus the startup is accelerated. For such a purpose, the recording apparatus may also have a function of finalizing the disk at a point in time when the user provides an instruction not to append it any more or at a point in time when one session is created. Thus, the above-mentioned excellent effect of accelerating the startup on the reproduction can be obtained.

(Third Embodiment)

As described above, according to the first and second embodiments of the present invention, it is possible, by storing the file size and recording position information in the recording position information file and reading and using this information on the reproduction, to obtain the file sizes and recording positions of the data files listed in the contents list information file without analyzing the contents of the file system, so that an excellent effect of significantly shortening the time from the insertion of the record medium to completion of the preparation for reproduction.

However, the process of creating the recording position information file requires processing equivalent to creating the recording data for the file system, and so the process is complicated. For this reason, there may also be the recording apparatus of creating only the contents list information file without creating and recording the recording position information file for the sake of simplifying the process of the recording apparatus.

At this time, in the case where the record medium having the contents list information file, recording position information file and data files recorded thereon is created once, and then the data is appended to the record medium by the recording apparatus of recording no recording position information file, only the contents list information file is updated and the recording position information file remains as-is. Consequently, a contradiction arises between the contents list information file and the recording position information file, and there arises a problem that the reproducing apparatus cannot normally perform the reproduction.

Next, the recording and reproducing system of solving such a problem according to a third embodiment of the present invention will be described.

The recording and reproducing system according to the third embodiment has the same configuration as that according to the second embodiment. The differences are that the information is added to the contents list information file and the recording position information file and the operation of the reproducing apparatus. This will be described hereafter.

FIG. 7 is a diagram showing an example of the contents list information file according to the third embodiment. It is different in that generation management information is stored in the header portion of the contents list information file according to the first and second embodiments shown in FIG. 2. The generation management information has 4-byte random numbers generated and stored therein.

FIG. 8 is a diagram showing an example of the recording position information file according to the third embodiment. It is different in that the generation management information is stored in the header portion of the recording position information file according to the first and second embodiments shown in FIG. 2. The generation management information stores the same value as that stored in the contents list information file.

Next, the operation of the reproducing apparatus according to the third embodiment will be described.

FIG. 9 is a flowchart showing a flow of a process of preparation for reproduction when a reproducing apparatus 10 detects that the record medium is inserted.

In a step 100, it analyzes the data of the file system first to obtain the file size and the recording position of the contents list information file, and accesses the contents list information file 16 based on that data to read the contents thereof. Next, in a step 101, it analyzes the data of the file system to determine whether or not the recording position information file is recorded on the record medium. If recorded, it moves on to a step 102 and reads the contents of the recording position information file, and in a step 103, it determines whether or not there is a match between the generation management information stored in the contents list information file and the recording position information file respectively. In the case where there is a match, in a step 104, it associates the data files listed in the contents list information file with the file sizes and recording positions stored in the recording position information file.

In the case where there is no match in the step 101 or 103, it means that there is no recording position information file or the contents are not corresponding to the contents list information file, and so it obtains the file size and recording position of each data file by a method of analyzing the file system in the past so as to associate them.

The flow of the process of the preparation for reproduction in the reproducing apparatus was described above.

Thus, it is possible, in the case where the contents list information file is updated but the recording position information file is not updated, to prevent the reproducing apparatus from accessing the files with wrong recording position information and falling into the operation in which normal reproduction is not possible. In addition, it has the same effect in the case of being mistakenly overwritten by the file having the same name as the contents list information file or the recording position information file.

(Fourth Embodiment)

In FIG. 5, the recording apparatus does not have the data recording state obtaining means 18 and the recording position information file creating means 34, and does not create or record the recording position information file. It stores a predetermined value in a generation field of the contents list information file.

The configuration of the reproducing apparatus is the same as that in FIG. 1. The preparatory operation for reproduction is different. The flow of the process is shown in FIG. 10. It is different from FIG. 9 in that it has a step 110 instead of the step 101. To be more specific, it is the operation in which the contents list information file is read, and if the generation field has the predetermined value, the file system is immediately analyzed without checking whether or not the recording position information file is recorded on the record medium.

The first to fourth embodiments were described in detail above.

Moreover, while it is described that the reproducing apparatus should perform the reproduction on the precondition that the instruction is provided by remote control as the reproduction instructing means 22, it is evident that an equivalent function can be implemented by the instruction provided by a panel mounted on the apparatus proper or the like.

Moreover, the program of the present invention is the program of having the functions of all or a part of the means (or apparatuses, elements and so on) of the above-mentioned recording and reproducing system of the present invention executed by a computer, which is the program operating in synergy with the computer.

In addition, the program of the present invention is the program of having the operations of all or a part of the steps (or processes, workings, actions and so on) of the above-mentioned recording and reproducing method of the present invention executed by the computer, which is the program operating in synergy with the computer.

In addition, the record medium of the present invention is the record medium supporting the program of having all or a part of the functions of all or a part of the means (or apparatuses, elements and so on) of the above-mentioned recording and reproducing system of the present invention executed by the computer, which is the record medium readable by the computer and having the above described functions performed by the above described program which is read in synergy with the above described computer.

In addition, the record medium of the present invention is the record medium supporting the program of having all or a part of the operations of all or a part of the steps (or processes, workings, actions and so on) of the above-mentioned recording and reproducing method of the present invention executed by the computer, which is the record medium readable by the computer and having the above described operations performed by the above described program which is read in synergy with the above described computer.

In addition, the record medium of the present invention is the record medium supporting a data structure utilized in synergy with the computer in all or a part of the means (or apparatuses, elements and so on) and the steps (or processes, workings, actions and so on) of the above-mentioned recording and reproducing system and recording and reproducing method of the present invention, which is the record medium readable by the computer and having the above described data structure which is utilized in synergy with the above described computer.

Moreover, the above “part of the means (or apparatuses, elements and so on)” of the present invention means one or a few of such a plurality of means, and the above “part of the steps (or processes, workings, actions and so on)” of the present invention means one or a few of such a plurality of steps.

In addition, the above “functions of the means (or apparatuses, elements and so on)” of the present invention means all or a part the functions of the above described means, and the above “operations of the steps (or processes, workings, actions and so on)” of the present invention means all or a part of the operations of the above described steps.

In addition, a form of using the program of the present invention may be the form recorded on the record medium readable by the computer and operating in synergy with the computer.

In addition, a form of using the program of the present invention may be the form transmitted in a transmission medium and read by the computer to operate in synergy with the computer.

In addition, the data structure of the present invention includes a database, a data format, a data table, a data list, a data type and so on.

In addition, the record media includes an ROM and so on, and the transmission media includes the transmission media such as the Internet, light, a radio wave, a sound wave and so on.

In addition, the above-described computer of the present invention is not limited to pure hardware such as a CPU, but may include firmware, an OS and peripherals on top of them.

Moreover, as described above, the configuration of the present invention may be implemented either software-wise or hardware-wise.

According to the above-mentioned embodiment, it is not necessary to determine whether or not an effective recording position information file corresponding to the contents of the contents list information file exists by analyzing the file system, so that an increase in the startup time can be prevented.

As is clear from the above description, the present invention has an advantage that the reproduction can be performed more promptly after the record medium is inserted.

1. a recording and reproducing system comprising:
a record medium holding a data file of storing predetermined data;
data file holding position information file recording means of recording data file holding position information on a position at which said data file is held in a data file holding position information file held on said record medium of storing said data file holding position information; and
data reproducing means of reproducing the predetermined data stored by said data file by using said data file holding position information which is recorded.

2. The recording and reproducing system according to claim 1, wherein:
said record medium holds a plurality of said data files, and
said data file holding position information file stores all the data file holding position information on the positions at which said plurality of data files are held respectively.

3. The recording and reproducing system according to claim 2, wherein:
said data file further stores parameter information used for reproducing said predetermined data;
parameter information recording means of recording said parameter information in a parameter information file held on said record medium of storing said parameter information is further provided; and
said data reproducing means reproduces the predetermined data stored by said data file by further using said parameter information which is recorded.

4. The recording and reproducing system according to claim 3, wherein said plurality of said data files are given unique data file IDs by using order in which said parameter information file stores said parameter information respectively.

5. The recording and reproducing system according to claim 4, wherein said data file holding position information on the positions at which said respective data files are held is recorded in said data file holding position information file by using said unique data file IDs which are given.

6. A recording and reproducing method comprising:
a data file holding position information file recording step of recording data file holding position information on a position at which a data file of storing predetermined data is held in a data file holding position information file held by a record medium holding said data file and said data file holding position information file; and
a data reproducing step of reproducing the predetermined data stored by said data file by using said data file holding position information which is recorded.

7. A program of, per recording and reproducing method according to claim 6, causing a computer to execute:
the data file holding position information file recording step of recording data file holding position information on a position at which a data file of storing predetermined data is held in a data file holding position information file held by a record medium holding said data file and said data file holding position information file; and
the data reproducing step of reproducing the predetermined data stored by said data file by using said data file holding position information which is recorded.

8. A record medium processable by a computer and supporting the program according to claim 7.
